(19) United States
(12) Patent Application Publication
(10) Pub. No.: US 2017/0092960 A1
(43) Pub. Date: Mar. 30, 2017

(54) Method of Preparation of Nano-Sized Materials and Apparatus Incorporating the Same

(71) Applicants: Alexey Serov, Albuquerque, NM (US); Plamen B. Atanassov, Santa Fe, NM (US); Sadia KABIR, Albuquerque, NM (US); Sarah STARIHA, Albuquerque, NM (US)

(72) Inventors: Alexey Serov, Albuquerque, NM (US); Plamen B. Atanassov, Santa Fe, NM (US)

(73) Assignee: STC.UNM, Albuquerque, NM (US)

(21) Appl. No.: 15/310,865

(22) PCT Filed: May 13, 2015
(86) PCT No.: PCT/US2015/030555

§ 371 Date: Nov. 14, 2016

Related U.S. Application Data
(60) Provisional application No. 61/992,732, filed on May 13, 2014.

(51) Int. Cl. H01M 4/92; H01M 4/88; H01M 8/1009

(52) U.S. Cl. CPC H01M 4/926; H01M 8/1009; H01M 4/8842

(57) ABSTRACT

Novel nano-sized materials and methods for making the same are described. The novel nano-sized materials are suitable for use as catalytic supports and, more specifically, can be decorated with one or more catalytic materials so as to form suitable catalysts for DLFC fuel cells utilizing alkaline media. The present disclosure also provides a small, portable, power supply system that incorporates catalysts utilizing the decorated nano-sized materials described herein.

### CROSS-REFERENCE TO RELATED APPLICATIONS

The following application claims benefit of U.S. Provisional Application No. 61/992,732, entitled “Method of Preparation of Nano-Sized Materials,” filed May 13, 2014, which is hereby incorporated by reference in its entirety.

### BACKGROUND

Fuel cells are receiving increasing attention as a viable energy-alternative. In general, fuel cells convert electrochemical energy into electrical energy in an environmentally clean and efficient manner. Fuel cells are contemplated as potential energy sources for everything from small electronics to cars and homes. In order to meet different energy requirements, there are a number of different types of fuel cells in existence today, each with varying chemistries, requirements, and uses.

There has recently been an increased interest in Direct Liquid Fuel Cells (DLFC). A Direct Liquid Fuel Cell (DLFC) is a device that can oxidize fuels through a series of electrochemical reactions to generate electrons that can be harvested to, for example, provide power for various applications. As opposed to indirect fuel cells that require prior reforming, DLFCs can use various fuels such as hydrazine, methanol, ethanol, formic acid, sodium borohydride, ammonia etc. either in the liquid or vapor form without any preliminary processing steps. Moreover, liquid fuels have higher energy densities, are easier to store, transport and refill, thereby making DLFCs perfect candidates for portable electronic devices.

Examples of DLFCs are Direct Methanol Fuel Cells (DMFC) [see e.g., S. Wasmusa, A, Küver, J. Electroanal. Chem. 1999, 461, 14-31.], Direct Ethanol Fuel Cells (DEFC) [see e.g., S. Song, P. Tsiakaras, Appl. Catal. B. 2006, 63, 187-193.], Direct Ethylene Glycol Fuel Cells (DEGFC) [see e.g., A. Serov, C. Kwak, Appl. Catal. B. 2010, 97, 1-12.], Direct Formic Acid Fuel Cells (DFAFC) [see e.g., X. Yu, P. G. Pickup, J. Power Sources 2008, 182, 124-132.], Direct Hydrazine Fuel Cells (DHFC) [see e.g., A. Serov, C. Kwak, Appl. Catal. B. 2010, 98, 1-93], Direct Dimethyl Ether Fuel Cells (DDEFC) [see e.g., A. Serov, C. Kwak, Appl. Catal. B. 2009, 91, 1-10.] and Direct Sodium Borohydride Fuel Cells (DSBFC) [see e.g., U. B. Demirci, P. Miele, Energy Environ. Sci. 2009, 2, 627-637.]. The usage of liquid fuels and anion-exchange membranes has substantial advantages in comparison to hydrogen-powered fuel cells. For example, liquid fuels have higher gravimetric and volumetric energy densities and the logistics of fuel delivery is much simpler in comparison with compressed hydrogen.

The advantages of operating in alkaline media as opposed to acidic media are described in, for example E. Antolini, E. R. Gonzalez, J. Power Sources 2010, 195, 3431-3450. Specifically, the increased reaction kinetics (particularly for organic fuels), the improved electrocatalyst stability, and the decreased fuel crossover rate (resulting from the flux of hydroxide anions from the cathode to the anode) in alkaline media enable the use of cheaper non-precious materials at both the anode and cathode sides of the fuel cell [see e.g., S. Spendelow, A. Wieckowski, Phys. Chem. Chem. Phys. 2007, 9, 2654-2675.]

However, the power output from DLFCs depends on the liquid fuel mass transport mechanisms and electrochemical activity of the supported catalysts. To achieve maximum power density, operating parameters such as reactant (gas or liquid) supply, structure of the components within the DLFC, and catalyst composition and loading have to be designed to yield the desired efficiencies.

The higher activity of palladium and palladium-based catalysts in alkaline media for alcohols electrooxidation reaction in comparison to platinum has been demonstrated [See e.g., E. Antolini, Energy Environ. Sci. 2009, 2, 915-931; R. M. Modibedi, T. Masombuka, M. K. Mathe, Int. J. Hydrogen Energy 2011, 36, 4664-4672; W. Du, K. E. Mackenzie, D. F. Milano, N. A. Deskins, D. Su, X. Teng, ACS Catalysis, 2012, 2, 287-297; E. E. Switzer, T. S. Olson, A. K. Datye, P. Atanassov, M. R. Hibbs, C. J. Cornelius, Electrochim. Acta, 2009, 54, 989-995; Z. Zhang, L. Xin, K. Sun, W. Li, Int. J. Hydrogen Energy, 2011, 36, 12686-12697; T. Maiyalagan, K. Scott, J. Power Sources, 2010, 195, 5246-5251; U. Martinez, A. Serov, M. Padilla, P. Atanassov, ChemSusChem, 2014, 7, 2351-2357; A. Zalineeva, A. Serov, M. Padilla, U. Martinez, K. Artyushkova, S. Baranton, C. Coutanceau, P. Atanassov, J. Am. Chem. Soc., 2014, 136, 3937-3945; and A. Serov, U. Martinez, P. Atanassov, Electrochem. Comm. 2013, 34, 185-188.].

In order to achieve better utilization and efficiency, supported catalysts are frequently used. Presently, carbon is one of the most extensively used materials for catalytic support. However, the majority of carbons have a substantial amorphous component, which is less conductive and durable than graphite [See e.g., L. Castanheira, L. Dubau, M. Mermoux, G. Berthomé, N. Caqué, E. Rossinot, M. Chatenet, F. Maillard, ACS Catal. 2014, 4, 2258]. On the other hand, highly graphitic materials usually have a low surface area. The common problem for both amorphous and graphitic materials is the weak interaction of noble metal nano-particles with the surface, which eventually leads to particle detachment and decreased catalyst durability.

Accordingly, there is a need for catalytic supports that are able to provide the advantages of carbon supports with the conductivity and durability of graphite. Moreover, the improved performance of catalysts incorporating such supports would enable the cost-effective production and utilization of fuel cell technology for applications like portable electronics.

### SUMMARY

In the present disclosure, novel nano-sized materials and methods for making the same are described. According to some embodiments, the novel nano-sized materials are suitable for use as catalytic supports and, more specifically, are decorated with one or more catalytic materials so as to form suitable catalysts for DLFC fuel cells utilizing alkaline media. According to yet another embodiment, the present disclosure provides a small, portable, DLFC-based power supply system that incorporates catalysts utilizing the decorated nano-sized materials described herein.

### BRIEF DESCRIPTION OF THE DRAWINGS

FIG. 1 is a schematic illustration of an exemplary synthesis route for palladium loaded 3D-GNS.

FIG. 2 is scanning electron microscope (SEM) image of chemically reduced Graphene nano sheets.

FIG. 3 is a schematic illustration of a Direct Liquid Fuel Cell (DLFC) stack according to an embodiment of the present disclosure.

FIG. 4A is an illustration of a serpentine pattern for a bipolar plate that could be used in a DLFC stack such as that shown in FIG. 3.

FIG. 4B is an illustration of a straight pattern for a bipolar plate.

FIG. 4C is an illustration of an interdigitated pattern for a bipolar plate.

FIG. 4D is an illustration of a spot/pin pattern for a bipolar plate.

FIG. 4E is an illustration of a spiral pattern for a bipolar plate.

FIG. 5 is a schematic illustration showing ethanol, carbon dioxide, and water transport taking place in a Direct Ethanol Fuel Cell.

FIG. 6 is a schematic illustration showing the fuel feed and gas exhaust system in a DLFC.

FIG. 7 is a block diagram of the DLFC system.

FIG. 8 is a schematic illustration of an exemplary DLFC.

FIG. 8 is an SEM image of a three dimensional graphene nanosheet (3D-GNS) according to the present disclosure.

FIG. 9 is a transmission electron microscope (TEM) image of a 3D-GNS according to the present disclosure.

FIG. 10 depicts X-ray diffractograms of different 30 wt % Pd/3D-GNS materials.

FIG. 11 is a TEM image of 30 wt % Pd/3D-GNS synthesized by SARM using EtOH as a solvent.

FIG. 12 is a TEM image of 30 wt % Pd/3D-GNS synthesized by SARM using IPA as a solvent.

FIG. 13 is a TEM image of 30 wt % Pd/3D-GNS synthesized by SARM using MeOH as a solvent.

FIG. 14 is a cyclic voltammograms of 30 wt % Pd-based electrocatalysts: Pd/XC72R (-), Pd/3D-GNS-MeOH (- - -), Pd/3D-GNS-EtOH (•••) and Pd/3D-GNS-IPA (- •-) vs. 1 M MeOH. Conditions: catalyst loading—200 μg cm⁻², 1 M KOH, 1600 RPM, 0.020 V s⁻¹.

FIG. 15 is a cyclic voltammograms of 30 wt % Pd-based electrocatalysts: Pd/XC72R (-), Pd/3D-GNS-MeOH (- - -), Pd/3D-GNS-EtOH (•••) and Pd/3D-GNS-IPA (- •-) vs. 1 M EtOH. Conditions: catalyst loading—200 μg cm⁻², 1 M KOH, 1600 RPM, 0.020 V s⁻¹.

### DETAILED DESCRIPTION

According to a general embodiment, the present disclosure provides novel nano-sized materials and methods for making the same. According to more specific embodiments, the nano-sized materials are suitable for use as catalytic supports. According to a still more specific embodiment, the nano-sized materials are decorated with one or more catalytic materials so that they can be used as catalysts in DLFC fuel cell applications utilizing alkaline media.

The presently described material provides the advantages of both carbon and graphite support materials by providing three-dimensional graphene nanosheets (referred to herein as 3D-GNS) that incorporate numerous defects and large pores. For the purposes of the present disclosure, the “large” pores in question may have an average pore diameter of between 5 and 250 nm However, it will be understood from further reading that the methods described herein enable the production of pores of virtually any size, shape, diameter, and density.

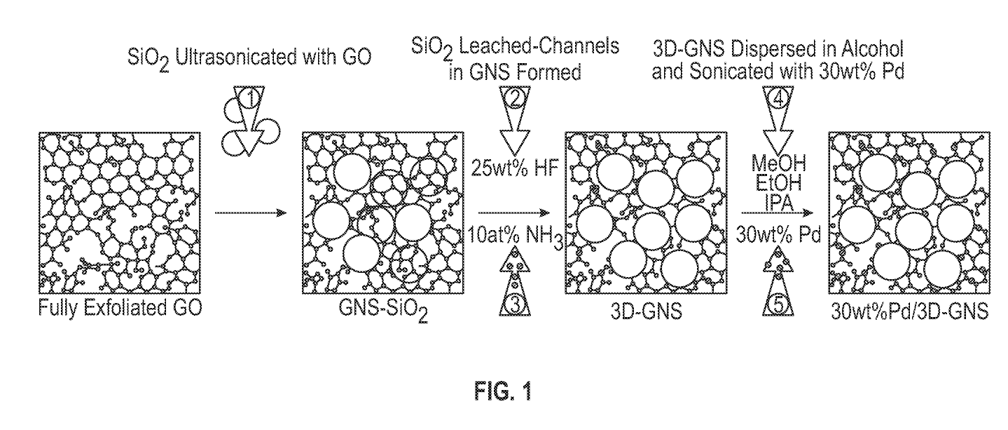

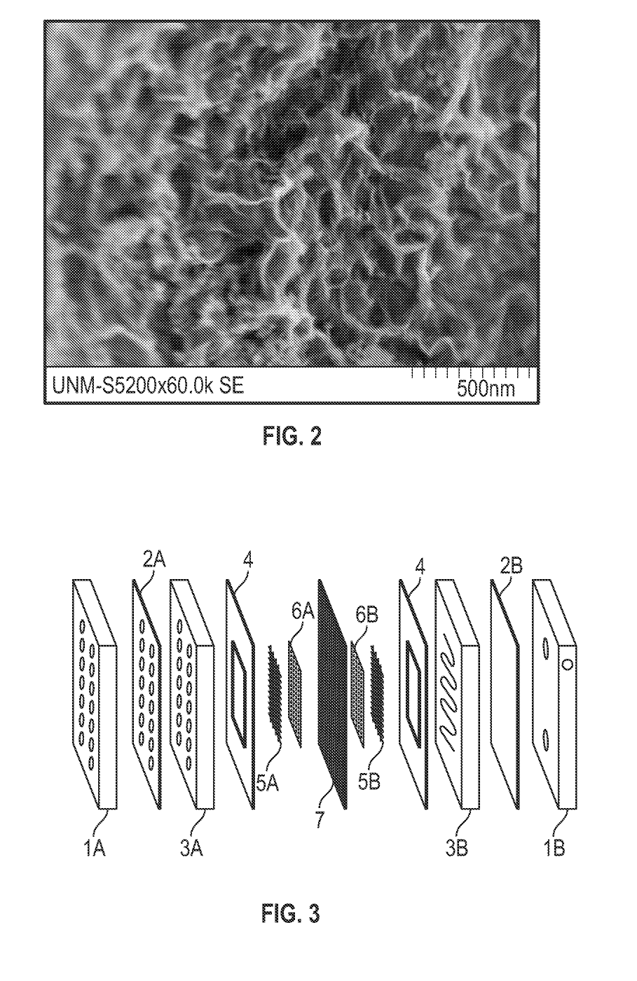

The 3D-GNS of the present disclosure are produced by mixing one or more graphene precursors, such as graphene oxide, or other carbons with sacrificial particles and reducing the mixture to produce a hybrid graphene nanosheet that incorporates the sacrificial particles as distinct elements within the nanosheet. The sacrificial particles are then removed, resulting in a “three-dimensional” graphene nanosheet incorporating a variety of defects and pores resulting from the removal of the sacrificial particles. See e.g., the first three steps of the exemplary synthesis route shown in FIG. 1. See also FIG. 2, which is a scanning electron microscope (SEM) image of a 3D nanosheet formed using the techniques described herein.

For the purposes of the present disclosure, the term “sacrificial particle” is intended to refer to a particulate material that is mixed with the graphene oxide and included during the graphene nanosheet synthesis process in order to provide temporary structure but which is mostly or entirely removed from the final product.

In general, it is well known that the synthesis of graphene oxide and graphene nanosheets is complicated due to the fact that most synthesis methods require that the material be washed from manganese salts and organic side products. This makes synthesis time consuming and not scalable and requires special vacuum set-ups or osmotic systems which then results in small batches and high prices for the final product. Accordingly, the present disclosure provides a methodology that is significantly less time consuming, scalable, and which does not require special equipment. Specifically, the presently described methodology substantially reduces the number of washing steps (the presently described method typically requires only one or two washes) because any organic material is evaporated during the reduction step and all unreacted manganese can be dissolved during removal of the sacrificial support. Because of these savings and due to the simplified nature of the disclosure process, our experiments were able to increase the batch size for lab-scale up to 20 g.

According to a specific embodiment, graphene oxide is produced using a modified Hummers method (see e.g., W. S. Hummers, R. E. Offeman, J. Am. Chem. Soc., 1958, 80, 1339). In general, graphite flakes are added to sulfuric acid (H₂SO₄) and potassium permanganate (KMnO₄) solution under continuous stirring over a heated water bath, followed by a slow addition of H₂O₂ (30%) to yield graphene oxide (GOx).

According to various embodiments of the present disclosure, the graphene oxide and sacrificial particles are mixed under suitable conditions. For example, the graphene oxide and sacrificial particles may be mixed in solution and/or using the mechano-chemical synthesis means as described below, in order to coat, deposit, impregnate, infuse, or similarly associate the graphene oxide with the sacrificial support. For the sake of simplicity, unless otherwise specified, the term “coat” is used herein as a catchall phrase to refer to any type of physical association, whether or not the “coating” is complete or partial and whether exclusively external or both internal and external. The graphene/sacrificial particle mixture is dried, if necessary, and reduced (for example via thermal or chemical reduction), and the sacrificial support removed, resulting in a porous, irregularly shaped, three-dimensional graphene nanosheet.

According to some embodiments, the graphene precursor(s) and sacrificial support particles may be mixed together under aqueous conditions using known solvents such as water, alcohols, or the like and using various known mechanical mixing or stirring means under suitable temperature, atmospheric, or other conditions as needed in order to enable or produce the desired degree of dispersion of sacrificial particles within the mixture. It should be understood that because the final morphology of the 3D-GNS material is determined by the size, shape, and relative placement of the sacrificial particles within the mixture, different applications may require or benefit from different ratios or degrees of dispersion of the particles within the graphene oxide- sacrificial particle mixture. For example, clumping of the particles (i.e. less even dispersion) with in the mixture could result in larger pores and a higher degree of irregularity, which could be desirable for some applications, which more evenly dispersed particles could result in a more even distribution of pores and more consistent pore sizes, which could be desirable in other applications. Suitable mixing means include, for example, use of an ultrasound bath, which also enables dispersion of the sacrificial support particles.

Alternatively or additionally, the graphene precursor(s) and sacrificial particles may be mixed together using mechano-chemical synthesis techniques such as high energy ultrasonic power or ball-milling.

It will be appreciated that the presently disclosed methods enable the production of graphene nano-sheet having highly controllable morphology. Specifically, by selecting the ratio of sacrificial support particles to graphene oxide and the size, shape, and even porosity of the sacrificial template particles, it is possible to control, select, and fine-tune the internal structure of the resulting 3D graphene nano-sheet material. In essence, the disclosed method enables the production of 3D nano-sheet having as convoluted and tortuous a morphology as desired. For example, a highly porous open-structure “sponge-like” material may be formed by using larger sacrificial template particles, while a highly convoluted, complex internal structure may be formed by using smaller, more complexly shaped, sacrificial particles, including for example, sacrificial particles of different shapes and/or sacrificial particles which are themselves porous. Moreover, the “density” of the 3D material can be selected by altering, for example, the ratio of sacrificial particles to graphene precursor materials, the shape of the template particles (i.e. how easily they fit together), or other factors.

Accordingly, it will be appreciated that the size and shape of the sacrificial particles may be selected according to the desired shape(s) and size(s) of the voids within the final product. Specifically, it will be understood that by selecting the particular size and shape of the support particles, one can produce a material having voids of a predictable size and shape. For example, if the template particles are spheres, the 3D material will contain a plurality of spherical voids having the same general size as the spherical particles.

As a specific example, assuming there is no alteration in the size of the particle caused by the synthesis method, in an embodiment where particles having an average diameter of 20 nm is used, the spherical voids in the final product will typically have an average diameter of approximately 20 nm. (Those of skill in the art will understand that if the diameter of the particle is 20 nm, the internal diameter of the void in which the particle resided will likely be just slightly larger than 20 nm and thus the term “approximately” is used to account for this slight adjustment.)

Accordingly it will be understood that the sacrificial particles may take the form of any two- or three- dimensional regular, irregular, or amorphous shape or shapes, including, but not limited to, spheres, cubes, cylinders, cones, etc. Furthermore, the particles may be monodisperse, or irregularly sized.

It will be further understood that because the material is formed using a sacrificial support technique, where the sacrificial material can be, for example, “melted” out of the supporting materials using acid etching or other techniques, the resulting material can be designed to have a variety of variously shaped internal voids which result in an extremely high internal surface area that can be easily accessed by, for example, gasses or liquids that are exposed to material (for example, in a fuel cell). Furthermore, because the size and shape of the voids is created by the size and shape of the sacrificial particles, materials having irregular and non-uniform voids can easily be obtained, simply by using differently shaped sacrificial particles and/or by the non-uniform distribution of sacrificial materials within the graphene precursor/sacrificial particle mixture. Furthermore, the sacrificial-support based methods of the present disclosure may produce catalysts having, for example, a bi-modal (or even multi-modal) pore distribution either due to the use of differently sized sacrificial particles or where a first smaller pore size is the result of removal of individual particles and thus determined by the size of the sacrificial particles themselves and a second, larger, pore size is the result of removal of agglomerated or aggregated particles. Accordingly, it will be understood that the method described herein inherently produces a material having a unique morphology that would be difficult, if not impossible, to replicate using any other technique.

As stated above, according to various embodiments, sacrificial particles of any size or diameter may be used. In some preferred embodiments, sacrificial particles having a characteristic length/diameter/or other dimension of between 1 nm and 100 nm may be used, in more preferred embodiments, sacrificial particles having characteristic length/diameter/or other dimension of between 100 nm and 1000 nm may be used and in other preferred embodiments, sacrificial particles having characteristic length/diameter/or other dimension of between 1 mm and 10 mm may be used. It should also be understood that the term “sacrificial particle” is used herein as a term of convenience and that no specific shape or size range is inherently implied by the term “particle” in this context. Thus while the sacrificial particles may be within the nanometers sized range, the use of larger or smaller particles is also contemplated by the present disclosure.

According to some embodiments, the sacrificial particles may themselves be porous. Such pores may be regularly or irregularly sized and/or shaped. The use of porous sacrificial particles enables the graphene precursor(s) to intercalate the pores, producing even more complexity in the overall three-dimensional structure of the resulting catalyst.

It will be appreciated that the sacrificial particles may be synthesized and mixed (or coated, or infused, etc.) in a single synthesis step or the graphene precursor(s) may be mixed with pre-synthesized (whether commercially purchased or previously synthesized) sacrificial particles.

Of course it will be appreciated that given the various conditions that the sacrificial template will be subjected to during the synthesis process, it is important to select a sacrificial material which is non-reactive to the catalytic materials under the specific synthesis conditions used and the removal of which will not damage the final material. For example, if the supporting material is to be used as an active support (i.e. a support which can synergistically promote the main catalyst), it is important that the method(s) used to remove the sacrificial particles not damage the support's active sites.

Silica is a material known to easily withstand the conditions described herein while remaining inert to a variety of catalytic materials including the metals described herein. Furthermore, silica can be removed using techniques that are harmless to graphene materials. Thus, silica is considered to be a suitable material from which the sacrificial template particles can be made. According to some specific embodiments, 20 nm diameter spheres formed from mesoporous silica can be used. In this case the templating involves intercalating the mesopores of the silica template particles and the resulting material typically contains pores in the 2-20 nm range. In one particular embodiment, the silica template is commercially available Cabosil amorphous silica (400 m²/g⁻¹). Furthermore, selecting a different type of silica can also alter the shape and size of the pores in the final 3D-GNS product. Those of skill in the art will be familiar with a variety of silica particles that are commercially available, and such particles may be used. Alternatively, known methods of forming silica particles may be employed in order to obtain particles of the desired shape and/or size.

However, while many of the examples herein utilize silica for the templating materials, it will be appreciated that other suitable materials may be used including, but are not limited to, zeolites, aluminas, clays, magnesia and the like.

As stated above, after the graphene precursor is mixed with the sacrificial support, the mixture is reduced to produce a hybrid graphene nanosheet that incorporates the sacrificial particles as distinct elements within the nanosheet. According to some embodiments, the hybrid material may be thermally reduced. Reduction may be performed, for example in hydrogen gas at a temperature of between 250 and 1200 K for between 30 and 240 minutes

After reduction, the hybrid GNS-sacrificial particle material can be ball-milled or subjected to high energy ultra sonic power to redisperse and thus form a more uniform powder, if desired.

The sacrificial particles are then removed resulting in an amorphous, porous, 3D nanosheet. Removal of the sacrificial template particles may be achieved using any suitable means. For example, the template particles may be removed via chemical etching. Examples of suitable etchants include NaOH, KOH, and HF. According to some embodiments, HF may be preferred as it is very aggressive and can be used to remove some poisonous species from the surface of the material. Accordingly, those of skill in the art will be able to select the desired etchants based on the particular requirements of the supporting material being formed.

After the sacrificial particles are removed, the 3D-GNS material may be further processed, as desired. As stated above, according to some embodiments, the 3D-GNS materials of the present disclosure may act as or form all or part of a support (or substrate) for one or more catalytic materials. According to various specific embodiments and as illustrated by the fourth step in FIG. 1, the 3D-GNS material of the present disclosure may be decorated with one or more materials having catalytic properties so as to produce a catalyst.

According to an embodiment, the 3D-GNS material described above is decorated with catalytic material such as platinum, palladium, or non-platinum group metal (non-PGM) catalysts. According to a specific embodiment, palladium (or another catalytic material) is decorated on the surface of the 3D-GNS material using a technique referred to herein as the Soft Alcohol Reduction Method (SARM). Advantageously, SARM enables the deposition of catalytic materials on a support without using any reducing agents other than the solvent itself. SARM is based on the reduction of palladium (or other catalytic material) precursors by the use of only a solvent. In general, particulate 3D-GNS is dispersed in a solvent. Suitable solvents include alcohols such as methanol (MeOh), ethanol (EtOh), and isopropyl alcohol (IPA). The 3D-GNS maybe dispersed using, for example, a high energy ultrasonic probe. A calculated amount of dissolved palladium (or other) precursor is then added to the dispersed 3D-GNS and mixed, for example via sonication. Suitable palladium precursors include, but are not limited to Palladium: nitrate, chloride, acetate, acetylacetonate etc. The solids are then precipitated, for example, via centrifugation. The precipitate is then washed. According to a specific embodiment, the precipitate is washed first with water, and then with the solvent. The mixture is then dried, resulting in 3D-GNS decorated with palladium.

According to still another embodiment, the decorated 3D-GNS can then be used as a catalyst for fuel cell applications, and is especially (though not exclusively) useful for DLFC applications utilizing alkaline media.

According to one specific embodiment, the decorated 3D-GNS of the present disclosure are incorporated into a Direct Liquid Fuel Cell (DLFC) such as that shown in FIGS. 3. It will be understood of course that the DLFC shown in FIG. 3 is a non-limiting example of one design for a DLFC and that those of skill in the art will be familiar with a wide variety of design variations and will thus understand that such variations are contemplated by the present disclosure. The DLFC shown in FIG. 3 includes an anode compartment comprising an anode catalyst layer 6B and an anode gas diffusion layer 5B; a cathode compartment comprising a cathode catalyst layer 6A and gas diffusion layer 5A; and a conductive ionomer membrane 7 interposed between the aforementioned anode and cathode compartments. In combination, components 5A, 5B, 6A, 6B and 7 make up the membrane electrode assembly (MEA), which is responsible for current generation. These layers are sandwiched between gaskets 4A and B, bipolar plates 3A and B, current collecting plates 2A and B, and endplates 1A and B to form a single cell DLFC stack.

According to the depicted embodiment, endplate 1A is an air breathing endplate that is on the cathode side of the DLFC. It is made of a metal plate with many small holes that allow ambient air into the cell for the oxygen reduction reaction. Endplate 1B is a closed endplate on the anode side of the DLFC with a gas inlet hole on the side that goes through the back. This hole is where the liquid fuel enters the cell. There is also a hole at the bottom of endplate 1B that is an outlet for the water produced. Endplate 1B can be made of the same metal as endplate 1A. Endplates 1A and 1B can be screwed or otherwise secured together to hold the entire cell together.

Current collecting plate 2A is an air breathing current collector made from a conductive metal such as copper on the cathode side of the DEFC. It has matching holes to complement endplate 1A. Electrons that are produced in the anode catalyst layer and that have traveled through an external circuit to create electricity reenter the cell through current collecting plate 2A. Current collecting plate 2B is a closed current collector on the anode side of the DLFC and can be made of the same material as current collecting plate 2A. Suitable materials include a conductive metal such as copper. Current collecting plate 2B has matching holes to complement endplate 1B. These holes allow the liquid fuel and the water to exit the fuel cell. The purpose of current collecting plate 2B is to transport the electrons produced in the anode layer to an external circuit to produce electricity.

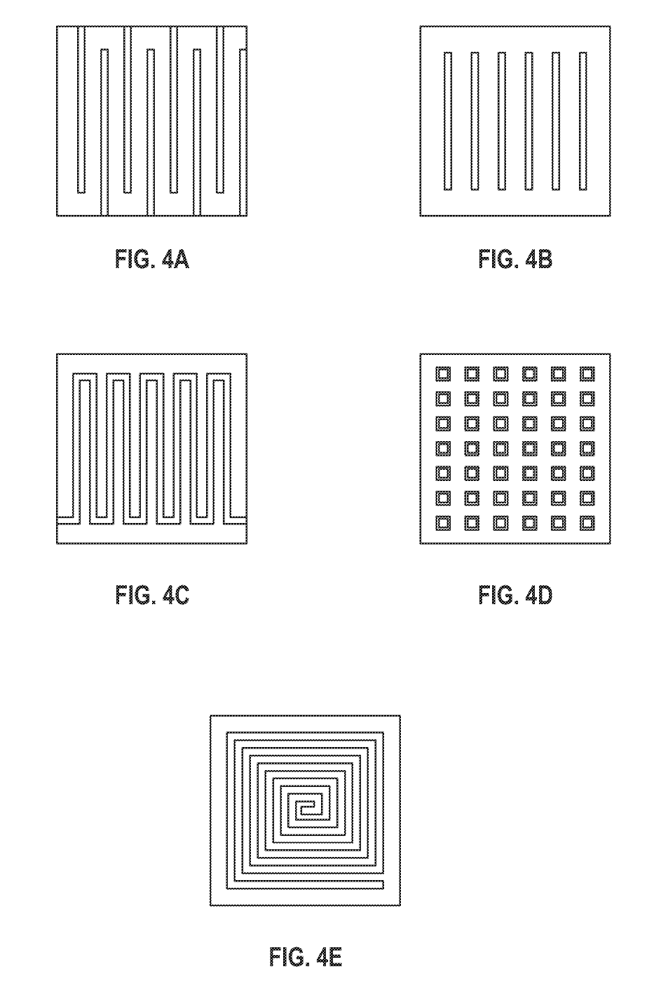

Bipolar plate 3A is an air breathing bipolar plate on the cathode side of the DLFC. It can be made, for example, of coated aluminum or graphite. If, however, the fuel is being oxidized in an alkaline media, bipolar plates made of alkali-resistant materials such as gold, copper, silver etc. may be used. Bipolar plate 3A may include holes that complement endplate 1A and current collecting plate 2A. According to the depicted embodiment, bipolar plate 3A has channels on the other side that are in a pattern to provide uniform flow. There are a variety of suitable bipolar plate patterns including, though not necessarily limited to those shown in FIG. 4. However, according to some embodiments, a serpentine pattern may be preferred for maximum and uniform fuel distribution. Particularly, symmetrical serpentine multiple flow channel arrangements are recommended for relatively large DLFCs (Liu, Li, Juarez-Robles, Wang, & Hernandez-Guerrero, 2014).

The purpose of bipolar plate 3A is to supply the air to the active site in the cathode catalyst layer, eliminate the water produced, and act as a connector to link multiple cells together to form a stack. Bipolar plate 3B is a closed bipolar plate on the anode side of the DLFC. It can be made of the same material as bipolar plate 3A including, for example, coated aluminum or graphite or in the case of alkaline media, alkali-resistant materials such as gold, copper, silver etc. and has matching holes to endplate 1B and current collecting plate 2B. In the depicted embodiment, it has channels on the other side that match those of bipolar plate 3A. The purpose of bipolar plate 3B is to supply the liquid fuel to the active sites in the anode catalyst layer, eliminate the water produced, and act as a connector to link multiple cells together to form a stack.

Gaskets 4A and B are gaskets typically made of a tear-resistant PTFE fiberglass or similar material that protects the catalyst layer from being crushed. Gas diffusion layer 5A is made from a porous carbon fiber paper or cloth, or similar material, that may or may not have a microporous layer. The purpose of gas diffusion layer 5A is to provide structure for the cathode catalyst layer, allow air into the cathode catalyst layer, and aid in water removal. Gas diffusion layer 5B can be made from the same porous carbon fiber paper or cloth (or similar material) that may or may not have a microporous layer as gas diffusion layer 5A. The purpose of gas diffusion layer 5B is to provide support for the anode catalyst layer, allow liquid fuel into the anode catalyst layer, and aid in water removal. The gas diffusion layer also assists in carbon dioxide diffusion through the anode catalytic layer, which should improve fuel supply to the anode catalytic layer.

Cathode catalyst layer 6A comprises a catalytic powder such as that described above, which can be either applied to the diffusion layer (5A) or directly on the ionomer membrane (7). Natural convection will supply air into the cathode compartment through the passive air breathing bipolar plate. Oxygen will be introduced in to the cathode compartment from the exterior of the fuel cell and into the cathode catalytic layer.

Anode catalyst layer 6B may also comprise a catalytic powder such as that described above applied to the diffusion layer (5B) or directly on to the membrane (7). According to a specific embodiment, this layer contains palladium nanoparticles supported on 3D-graphene for ethanol oxidation in a preferred mixture of 5-99 wt % Pd and 3D-Graphene. The anode material thus produced is in contact with the ionomer membrane (7) and the gas diffusion layer (5B).

Conductive ionomer membrane 7 facilitates the transfer of anions or cations between anode and cathode catalyst layers, depending on the pH of the electrolyte being used in the DLFC. In general, proton exchange Nafion® membranes which comprise a polytetrafluoroethylene (PTFE) backbone with sulfonate heads—are widely used for PEM fuel cells in acidic media.

However, the electro-oxidation kinetics for many liquid fuels as well as oxygen reduction reactions are enhanced in alkaline environments that use Anion exchange membranes (AEM). The purpose of AEMs is to conduct hydroxide (OH—) anions as opposed to cations from the cathode to the anode compartment, which results in several other advantages such as reduced crossover of liquid fuels (see, e.g., Arges, Ramani, & Pintauro, 2010 Arges, C. G., Ramani, V., & Pintauro, P. N. (2010). The Chalkboard: Anion Exchange Membrane Fuel Cells. Interface, 19(2).) This permits the use of more concentrated fuels which is beneficial for portable applications. Therefore, in the context of the present invention, it is preferred that anion exchange membranes (AEM) are used for DLFC.

To assemble the MEA first the anode and cathode catalytic layers (6B and 6A) must be applied to the desired supporting structure. According to a specific embodiment, the anode catalytic layer may comprise an ink formed by mixing the Pd and 3D-Graphene catalyst described above and an anion or proton exchange ionomer (Nafion®) using balling milling, high sheer homogenizing or other similar techniques. An automated printer or other suitable device including a hand airbrush or decal, can then be used to apply the catalyst layer. According to some embodiments the catalytic layer is sprayed directly on to the AEM. Suitable commercial-available AEMs such as those from Tokuyama Co, or Fumatech's Fumasep®FAA or other AEM suppliers may be used. According to some embodiments, the AEM is soaked in 0.5 M KOH for 24 hours and then soaked in DI water for 24 hours before the catalysts are sprayed directly on to it. If an acidic medium is to be used, the anode catalyst ink can be made with proton exchange ionomer (Nafion®) and can be applied to either the Nafion® proton exchange ionomer membrane or to the gas diffusion layer. The cathode catalyst layer can be applied following the same procedure as above.

The MEA is then assembled in the following order; gasket (4), gas diffusion layer (5B), anode catalyst layer (facing up) (6B), ionomer membrane (7), cathode catalyst layer (facing down) (6A), gas diffusion layer (5A), gasket (4). The MEA is then pressed between two stainless or any type of metal plates in a heated press at 130° C. at 50-1500 psi for 1-60 minutes. Once it is taken out of the press the MEA is cooled under a 0.2-120 lb weight for 1-60 minutes. MEAs can have any suitable electrode area including, for example, 5, 25, 50, or 100 cm², but it will be understood that the specific are will be determined by the needs of the desired final product.

A single DLFC is assembled in the following order; air breathing endplate (1A), air breathing current collector (2A), air breathing bipolar plate (3A), MEA (cathode side down), closed bipolar plate (3B), closed current collector (2B), and closed endplate (1B). Screws are placed in the closed endplate (1B) and tightened into the air breathing endplate (1A) to produce an evaluation single cell.

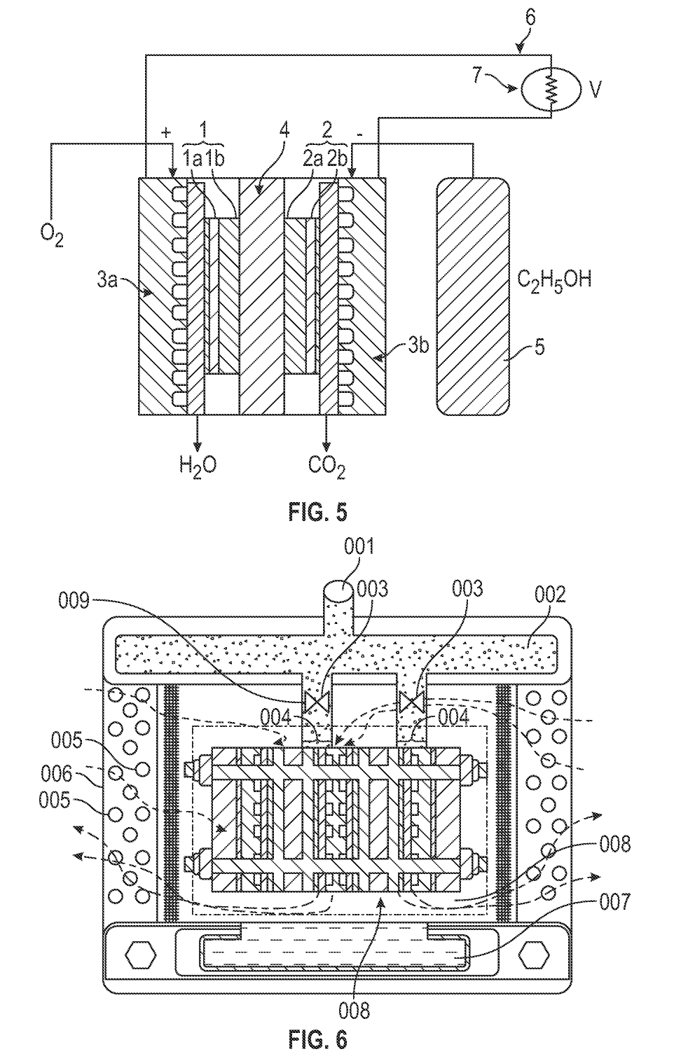

Turning now to FIG. 5, a schematic illustration of ethanol, carbon dioxide, and water transport in an exemplary Direct Ethanol Fuel Cell is shown. As shown, A reservoir 5 for the temporary storage of liquid fuel, for example, ethanol (C₂H₅OH) either in its concentrated or diluted state—is connected to the inlet passage of the anode bipolar plate 3b. Liquid ethanol from the reservoir is supplied to the anode catalyst layer 2a in the anode compartment 2 either through liquid supply pumps or distributed from an overhead reservoir passively by allowing the liquid fuel to flow under gravity and natural capillary forces.

As ethanol is circulated in the anode compartment through the serpentine grooves in the bipolar passage plates, it diffuses through the anodic diffusion layer 2b and is oxidized according to the following conditions:
a. In an acidic media, ethanol undergoes electro-oxidation to produce carbon dioxide, protons and electrons according to the equation: C₂H₅OH+3H₂O→CO₂+12H++12e⁻. The protons permeate into conductive polymer electrolyte membrane and cross over to the cathode compartment 1.
b. However, in an alkaline media with Anion Exchange Membranes, the ethanol oxidation reaction changes to: C₂H₅OH+12OH⁻→2CO₂+9H₂O+12e⁻ Where the OH− ions transported from the anode 1 to the cathode 2 compartment.

Carbon dioxide formed in the anode catalytic layer during ethanol oxidation is in its gaseous phase. The carbon dioxide bubbles diffuse to the top of the gas diffusion layer at the outlet of the pores and is removed.

The electrooxidation of ethanol releases electrons which are subsequently transferred to the cathode compartment conducting plates via an external circuit 6. Herein, oxygen, protons and electrons combine to produce water according to the oxygen reduction reaction:

Acidic Media: 3O₂+12H⁺+12e⁻→6H₂O
Alkaline Media: 3O₂+6H₂O+12e⁻→12OH⁻

Meanwhile, the oxidizing gas i.e. O₂ is supplied into the cathode compartment 1 of the MEA via breathing bipolar plate 3a. Within the MEA, O₂ diffuses into the cathode catalytic layer lb through the gas diffusion layer 1a where it is eventually reduced to water. The reactants (O₂ and C₂H₅OH) and their mobile species in the polymer electrolyte depend on the pH.

The overall cell reaction is C₂H₅OH+3O₂→2CO₂+3H₂O

Electrons generated from the oxidation-reduction reactions are collected by graphite bipolar plates and be harvested by applying an external load to power portable electronics.

FIG. 6 is a schematic illustration showing the structure of a DLFC system containing two or more cells. The cells can be stacked and connected to each other in series. A concentrated or diluted solution of the fuel is introduced into the DEFC via an inlet 001. Is it preferred that the fuel is concentrated to minimize crossover. The fuel solution is temporarily stored in an internal reservoir 002. The fuel is supplied to the anode compartments 004 of the fuel cell stack 008 through a supply port 009. It should be noted that the reservoir and its components should be made of a material that does not dissolve or react with the fuel. The height of the reservoir can be increased to accommodate additional storage of ethanol.

Once the reservoir is filled, the fuel is primarily fed and passively distributed into the anode compartments via the inlet under gravity. Alternatively, a controlled flow can be achieved by installing valves 003. However, according to some embodiments it may be desirable for a passive system to be implemented for fuel distribution to minimize costs and reduce complexity of adding extra components such as sensors, thereby keeping the DLFC compact. According to some embodiments the fuel is recirculated around the cell until fully exhausted and replenished with more fuel by filling up the temporary reservoir 009. The anode feeding channels 009 are separated from the cathode air feeding channels to prevent fuel and air mixing outside the stack compartment.

As the fuel circulates and diffuses into the anode catalytic layer, it is oxidized to carbon dioxide, protons and electrons. Most of the carbon dioxide formed during oxidation in the anode catalytic layer is in the gas phase and diffuses to the top of the gas diffusion layer. There, carbon dioxide bubbles form at the outlet of the pores and diffuses out of the MEA where it is discharged into the atmosphere through the holes provided in the back plates 006 of the fuel cell stack 008.

In the meantime, ambient air passively flows from the exterior of the fuel cell and is primarily fed into the cathode compartment of the fuel cell stack through natural convection. An air filter is provided to filter out any impurities that could reduce the performance of the fuel cell. 02 from the air undergoes electrochemical reduction where it is reduced to water. It should be noted that the flow of the fuels and air will depend on the buoyancy and capillary forces that are resulting from the gradient in the bubble void fraction along the flow channel and will therefore require no external force in the form of pumps. Moreover, eliminating pumps will minimize costs and complexity of the air feed system.

The water produced during the oxidation reduction reaction in the cathode compartment can either be in its vapor form and exit the stack along with carbon dioxide through the back plates, or it could be condensed in its liquid form, in which case it can be collected in a container 006. The container is provided to temporarily store water and then can be detached for disposal.

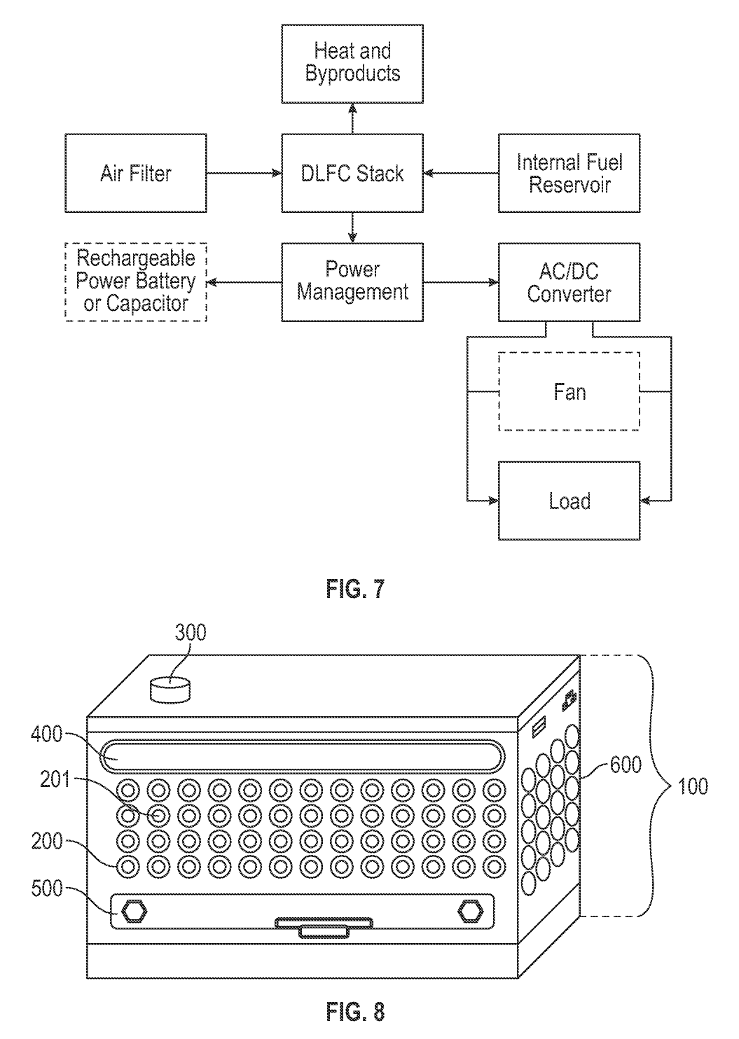

FIG. 7 is a block diagram showing an operation scheme for a direct liquid fuel cell. The depicted DLFC requires no pumps and is self-operated via electrochemical oxidation reduction reactions taking place in their respective anode and cathode compartments in the fuel cell stack.

According to various embodiments the DLFC could include any of the following optional components such as: a rechargeable Li battery placed to provide power when ethanol is not being supplied as the fuel and a fan to provide forced convection of the air into the fuel cell stack as well as for cooling.

FIG. 8 is another schematic illustration of a potential commercial embodiment of a DLFC according to the present disclosure. As shown, the external compartment of the DLFC includes a plastic case 100 at the top and bottom to enhance durability and keep the DLFC light weight. The metal exterior 200, which may be formed from, for example, Aluminum, is engraved with fins (not shown) and holes 201 to provide air convection and prevent overheating. A supply inlet 300 on the top plastic surface introduces the fuel in to the DLFC. An external glass cover 400 is provided for visual detection of the level of fuel being supplied to the internal reservoir. A detachable container 500 is provided in the bottom to collect and dispose of any liquid byproducts that may collect during operating conditions. The case also consists of USB connectors and 3 pin power outlets 600 for setting up a connection to power mobile electronics.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. The methods and processes illustratively described herein suitably may be practiced in differing orders of steps, and that they are not necessarily restricted to the orders of steps indicated herein or in the claims. As used herein and in the appended claims, the singular forms “a,” “an,” and “the” include plural reference unless the context clearly dictates otherwise. Thus, for example, a reference to “a catalyst” may include a plurality of such catalysts, and so forth.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

All patents and publications identified above or below and/or mentioned herein are indicative of the levels of skill of those skilled in the art to which the invention pertains, and each such referenced patent or publication is hereby incorporated by reference to the same extent as if it had been incorporated by reference in its entirety individually or set forth herein in its entirety. Applicants reserve the right to physically incorporate into this specification any and all materials and information from any such cited patents or publications. Furthermore, inclusion or identification of a reference in the present disclosure does not, in and of itself, act as an admission that such publication is prior art to the inventions of present disclosure.

Additional information may be gathered from the Examples section below.

### EXAMPLES

I. Preparation of 3D-GNS by the Sacrificial Support Method. Synthesis of 3D-GNS began with the preparation of graphene oxide (GO) by the modified Hummers method [W. S. Hummers, R. E. Offeman, J. Am. Chem. Soc., 1958, 80, 1339.]. The prepared graphene oxide was stored in its wet form until used for further synthesis.

Synthesized GO was fully exfoliated in a water solution using a high power ultrasonic probe (600 kJ were delivered to 10 g of GO in 1 L of de-ionized (DI) water for 2 hours) followed by the addition of 20 g of EH-5 fumed silica (Cab-O-Sil, surface area ˜400 m2 g−1). The mixture of GO-SiO₂ was ultrasonicated for 1 more hour and dried overnight at T=358 K. Dry powder was ball-milled at 400 revolutions per minute (RPM) for 15 minutes and subjected to reduction in 7% H₂ (flow rate=100 ccm) at T=1073 K for 1 hour. After reduction, this hybrid GNS-SiO₂ was ball-milled at 400 RPM for 15 minutes. The silica support was leached by means of 25 wt % HF for 24 h followed by continuous filtration until a neutral pH was achieved. The resulting 3D-GNS was dried overnight at T=358 K and its powdered form was doped with nitrogen in 10% NH₃ (flow rate =100 ccm) at T=1123 K for a duration of 2 hours. The subsequent 3D-GNS was used as a support material for palladium deposition.

II. Preparation of Pd/3D-GNS by Soft Alcohol Reduction Method. 1 g of 3D-GNS was dispersed in the alcohol of choice (MeOH, EtOH or IPA) using a high energy ultrasonic probe. A calculated amount of Pd(NO₃)₃*2 H₂O (in order to get 30 wt % on 3D-GNS) was dissolved in water (in order to get a 50:50 final mixture, by volume with the alcohol of choice) and added to the 3D-GNS while sonicating for 15 minutes and then centrifuged. The black precipitate was washed twice with de-ionized (DI) water followed by a wash of the alcohol of choice two times. The mixture was dried to a powder at T =85° C. overnight. In order to compare the activity of palladium supported on 3D-GNS or on a conventional carbon support, 30 wt % Pd/XC72R (Cabot, Vulcan XC72R) was synthesized by SARM from EtOH.

III. Physical characterization. Morphologies of the synthesized materials were determined by SEM (Hitachi S-5200 Nano SEM with an accelerating voltage of 10 keV) and TEM (JEOL 2010 instrument with an accelerating voltage of 200 keV). Powder X-ray diffraction analysis was performed using a Rigaku Smartlab diffractometer with Bragg-Brentano focusing geometry. The X-ray source used was a Cu anode operating at 40 kV and 40 mA. The 2θ angle extended from 10 to 140° at a continuous scan rate of 4 degrees per minute. Collected intensities were integrated over a step size of 0.02°. The detector used was the Rigaku D/teX Ultra 250 1D silicon strip detector with a K-β incident beam monochromator. The average XRD crystallite size was obtained from a fit of the (hkl) and (h′k′l′) peaks using the Debye-Scherrer equation. Specific surface areas were measured by the N2-BET method using a Micrometrics 2360 Gemini Analyzer.

IV. Electrochemical characterization. The electrochemical analyses of the synthesized materials were performed using the Pine Instrument Company electrochemical analysis system. The rotational speed is reported at 1600 RPM, with a scan rate of 0.020 V s-1. The electrolyte was 1 M KOH saturated in N2 at room temperature. A platinum wire counter electrode and a Hg/HgO reference electrode were used.

The working electrodes were prepared by mixing 5 mg of the 30 wt % Pd/3D-GNS electrocatalyst with 925 μL of a water and isopropyl alcohol (4:1) mixture, and 75 μL of Nafion® (0.5 wt. %, DuPont). The mixture was sonicated for 3 minutes before 10 μL was applied onto a glassy carbon disk with a sectional area of 0.247 cm2. The catalyst loading on the electrode was 0.2 mg cm-2 30 wt %Pd/3D-GNS.

Electrooxidation of 1 M MeOH and 1 M EtOH in 0.1 M KOH was studied on the synthesized catalysts.

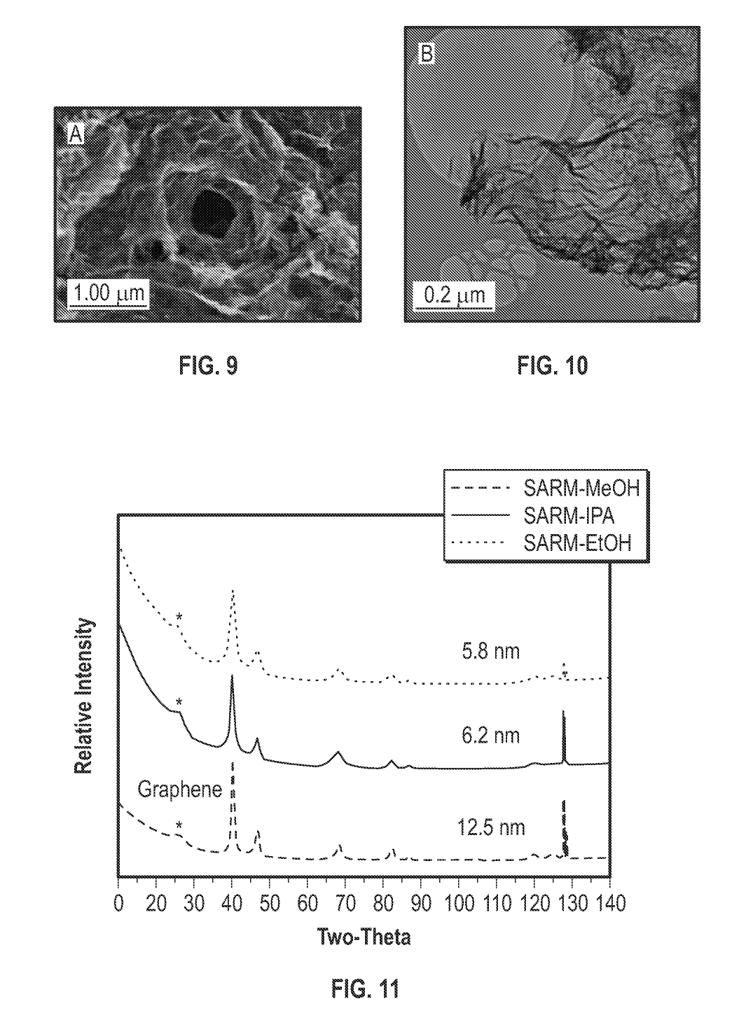

V. Results and Discussion. Morphological analysis of the 3D-GNS was performed by SEM and TEM (FIGS. 9 and 10, respectively). It can clearly be seen that the synthesized material has numerous structural defects and large pores. The latter were formed after removal of the silica support. The surface area of the 3D-GNS was found to be around 450 m² g⁻¹, which is substantially higher than graphite material (around 1-5 m² g⁻¹).

We investigated the influences of the morphology and activity of palladium nano-particles with the following alcohol solvents: methanol, ethanol and iso-propyl alcohol. The volumetric ratio between alcohol and water was selected as 1:1. Prior to the deposition of Pd on 3D-GNS, model experiments were performed without any substrate addition. The fastest reduction of palladium nitrate was observed in the case of EtOH addition, wherein after 5 s the solution turned to black. The second fastest alcohol for Pd nitrate reduction was IPA, where after 5 min the solution was still brown. The slowest reduction was found in the case of MeOH, where even after 15 minutes, the solution was a semi-transparent pale-brown.

After washing and drying, the synthesized Pd/3D-GNS samples were characterized by X-ray diffraction (XRD) and transmission electron microscopy (TEM). Analysis of XRD spectra revealed the complete reduction of palladium nitrate into Pd° (FIG. 11). We did not observe any other materials in the samples aside from graphene and metallic palladium. The smallest crystallites were found in the alcohols following the order EtOH>IPA>MeOH. This can be explained by the relative reduction power of the alcohols as mentioned above. The high reduction power of alcohol results in the formation of larger amounts of nucleation seeds, and due to the fact that the concentration of precursors is finite, there is no substantial growth of those initial particles. In the case of MeOH, fewer nucleation seeds were formed, which continued to grow with time.

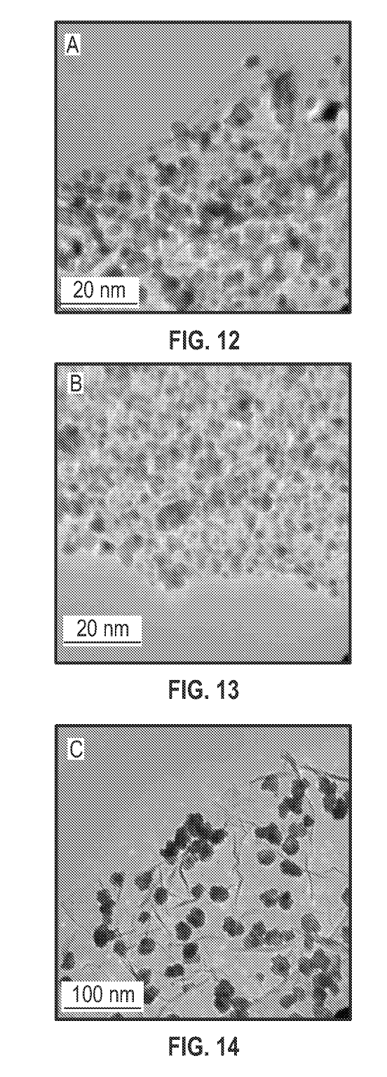

Analysis of the TEM images (FIGS. 12-14) confirms the XRD data: the catalysts synthesized by SARM EtOH and IPA consist of 3D-GNS evenly populated by non-agglomerated Pd nano-particles.

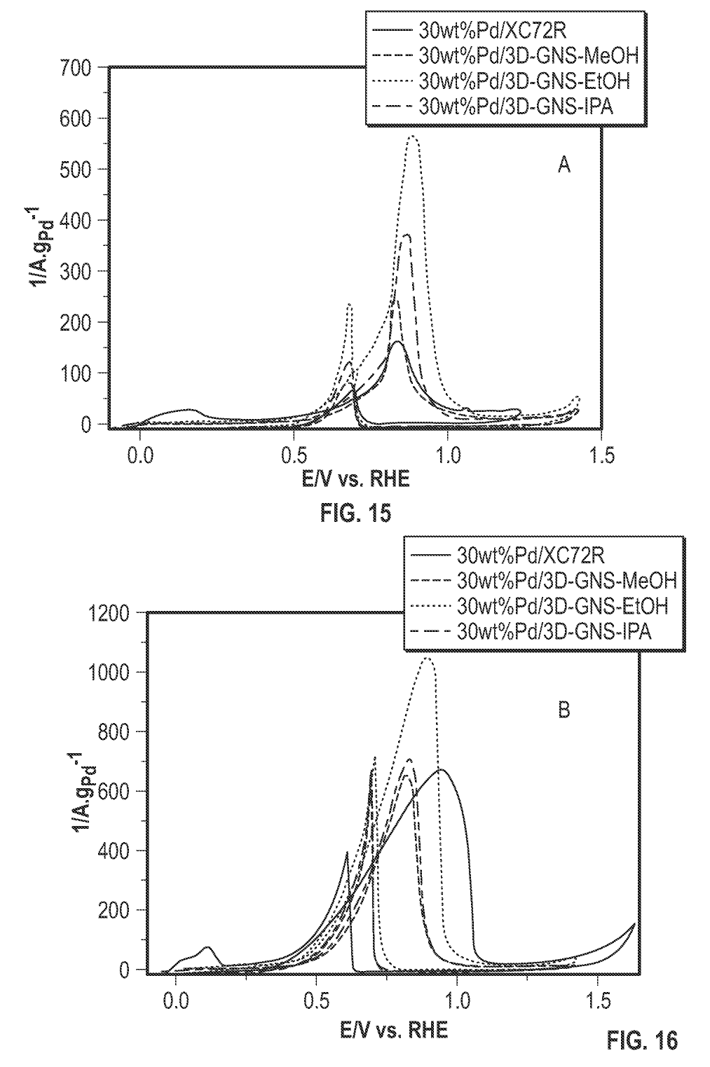

Electrochemical performance of Pd/3D-GNS materials in comparison with Pd/XC72R in the reaction of MeOH and EtOH electrooxidation is presented in FIGS. 15 and 16. The most active material was derived from SARM-EtOH, and the less active from SARM-MeOH, which was even less active than the reference Pd/XC72R. The better mass activity of the SARM-EtOH catalyst can be explained by having the smallest particles that were finely dispersed on the surface of the 3D-GNS.

What is claimed is:

1. A three-dimensional graphene nanosheet comprising a plurality of pores and/or defects.

2. The three-dimensional graphene nanosheet of claim 1 wherein at least some of the pores and/or defects are formed by the removal of sacrificial particles.

3. The three-dimensional graphene nanosheet of claim 1 decorated with a catalytic material.

4. The three-dimensional graphene nanosheet of claim 3 wherein the catalytic material is palladium.

5. The three-dimensional graphene nanosheet of claim 3 wherein the catalytic material was decorated using the soft alcohol reduction method.

6. A method for forming a material comprising:
mixing a graphene precursor and sacrificial particles;
reducing the mixture to form a hybrid material comprising a graphene nanosheet and distinguishable sacrificial particles embedded within the graphene nanosheet;
removing the sacrificial particles to form a three-dimensional graphene nanosheet comprising a plurality of pores and/or defects formed by the removal of the sacrificial particles.

7. The method of claim 6 wherein the graphene precursor is graphene oxide.

8. The method of claim 6 wherein the sacrificial particles are silica particles.

9. The method of claim 6 further comprising ball milling the mixture.

10. The method of claim 6 further comprising ball milling the three-dimensional graphene nanosheet.

11. The method of claim 6 further comprising decorating the three-dimensional graphene nanosheet with a catalytic material.

12. The method of claim 11 wherein the three-dimensional graphene nanosheet is decorated with the catalytic material by:
dispersing a particulate form of the three-dimensional graphene nanosheet in a solvent;
adding a dissolved precursor of the catalytic material to the dispersed particulate form of the three-dimensional graphene nanosheet; and
precipitating the decorated three-dimensional graphene nanosheets.

13. The method of claim 12 further comprising sonicating the dissolved precursor and dispersed particulate form of the three-dimensional graphene nanosheet.

14. The method of claim 13 wherein the solvent is selected from the group consisting of ethanol, methanol, and isopropyl alcohol.

15. A direct liquid fuel cell (DLFC) comprising a membrane electrode assembly comprising an anode catalyst and a cathode catalyst wherein at least one of the anode or cathode catalysts comprises a three-dimensional graphene nanosheet decorated with a catalytic material.

16. The DLFC of claim 15 wherein the three-dimensional graphene nanosheet decorated with a catalytic material comprises a plurality of pores and/or defects formed from the removal of sacrificial particles.

17. The DLFC of claim 16 wherein the catalytic material is palladium.

18. The DLFC of claim 17 wherein the three-dimensional graphene nanosheet was decorated with platinum by:
dispersing a particulate form of the three-dimensional graphene nanosheet in a solvent;
adding a dissolved precursor to the catalytic material to the dispersed particulate form of the three-dimensional graphene nanosheet; and
precipitating the decorated three-dimensional graphene nanosheets.
